(19) United States
(12) Patent Application Publication
(10) Pub. No.: US 2024/0320130 A1
(43) Pub. Date: Sep. 26, 2024

(54) AUTOMATED APPLICATION PROGRAMMING INTERFACE TESTING

(71) Applicant: INTERNATIONAL BUSINESS MACHINES CORPORATION, Armonk, NY (US)

(72) Inventors: Devika Sondhi, Noida (IN); Swagatam Haldar, Kolkata (IN); Diptikalyan Saha, Bangalore (IN); Margaret Mary Dhanaswamy, Bangalore (IN); Saritha Route, Bangalore (IN); Aman Goyal, Bangalore (IN)

(21) Appl. No.: 18/186,878

(22) Filed: Mar. 20, 2023

(51) Int. Cl. G06F 11/36; G06F 9/54

(52) U.S. Cl. CPC G06F 11/3684; G06F 9/54; G06F 11/3676; G06F 11/3688

(57) ABSTRACT

Automated testing of an application programming interface (API) includes determining features of an application programming interface (API). The features include operations of the API, one or more resources used by each operation, and resource-based dependencies between the operations. A resource-specific group of operations is generated. The operations within the resource-specific group operate on a selected resource selected from the one or more resources. A sequence of operations is generated by ordering the operations within the resource-specific group based on resource-based dependencies between the operations within the resource-specific group. A functional test case of the API based on the sequence of operations is output for testing the API.

### BACKGROUND

This disclosure relates to application programming interfaces (APIs), and, more particularly, to automated testing of APIs.

A frequently used technique for testing application software is execution of a test case. A test case typically specifies inputs, execution conditions, testing procedures, and expected results of the execution of the software to be tested. An API defines a set of particular rules that enable different applications to communicate with each other. Given the extensive and increasing use of APIs, their testing is especially important. For a particular API, a functional test suite requires specified inputs capable of verifying execution of each operation, as well as validation of each sequence of operations of the particular API.

### SUMMARY

In one or more embodiments, a method includes determining, by a specification analyzer, features of an application programming interface (API). The features include operations of the API, one or more resources used by each operation, and resource-based dependencies between the operations. The method includes generating, by a sequence generator, a resource-specific group of operations. The operations within the resource-specific group operate on a selected resource selected from the one or more resources. The method includes generating, by the sequence generator, a sequence of operations by ordering the operations within the resource-specific group based on resource-based dependencies between the operations within the resource-specific group. The method includes outputting, by a test execution engine, a functional test case of the API based on the sequence of operations.

The foregoing and other implementations can each optionally include one or more of the following features, alone or in combination. Some example embodiments include all the following features in combination.

In one aspect, determining resource-based dependencies includes performing a parameter matching of parameters of the operations.

In another aspect, the resource-based dependencies correspond to producer-consumer relations between operations.

In another aspect, the method includes determining subtypes of the operations of the API and generating the sequence of a resource-specific group of operations based on subtypes of the operations within the resource-specific group.

In another aspect, generating the sequence of operations includes determining, using a transformer language model, probabilities of multiple permutations of orderings of operations within the resource-specific group. The operations within the resource-specific group are permutated based on recognized verbs of the operations and the sequence generated is based on a permutation having the greatest probability.

In another aspect, the method includes executing the functional test case on a system under test and performing a response check with respect to each of the selected operations.

In another aspect, the method includes generating additional functional test cases of selected operations. The operations may be arranged based on the sequence of operations using different combinations of parameter values for the selected operations.

In another aspect, the sequence of operations is a lifecycle-based sequence corresponding to the lifecycle of the selected resource.

In another aspect, the sequence of operations is an operation-based sequence.

In one or more embodiments, a system includes one or more hardware processors configured to execute operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing an automated API test (AAT) framework.

FIG. 2 illustrates an example architecture for the AAT framework of FIG. 1.

FIG. 3 illustrates an example method of operation of the AAT framework of FIGS. 1 and 2.

FIG. 4 illustrates an example API specification used by the AAT framework of FIGS. 1 and 2.

FIG. 5 illustrates example resource-specific groupings of API operations by the AAT framework of FIGS. 1 and 2.

FIGS. 6A and 6B illustrate example sequences of operations generated by the AAT framework of FIGS. 1 and 2.

FIG. 7 illustrates an example typing and subtyping of API operations by the AAT framework of FIGS. 1 and 2.

FIG. 8 illustrates an example functional API test case generated by the AAT framework of FIGS. 1 and 2.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to APIs, and, more particularly, to automated testing of APIs. Notwithstanding the importance of testing of APIs, technical challenges remain. These challenges continue to limit many conventional API testing systems and techniques. Conventional API testing typically involves using all the basic compute operations for each resource apart from testing each operation independently. Thus, conventional techniques produce one long sequence of operations or multiple sequences that are not functionally valid (e.g., duplicate operations). Attempts to create valid sequences based on feedback from previous executions often do not ensure validity (e.g., no operation outputs a resource required as input for a subsequent operation). Moreover, techniques that are dependent on feedback to ensure functional validity are incapable of generating API test cases offline, which is often of practical importance in API testing.

In accordance with the inventive arrangements described herein, methods, systems, and computer program products are provided that are capable of generating functional test cases using a resource-specific group of operations. As used herein, a “resource-specific group of operations” means a group or collection of API operations that sequentially operate on a single, common resource.

The inventive arrangements are described herein mainly in the context of a REST API—an API that follows the REST (REpresentation State Transfer) architecture. REST is a set of instructions that permits sharing of resources and services by different systems. The core of the REST architecture is to define named resources (also known as nouns) that are manipulated using a small number of operations (also known as verbs or methods). A REST resource is an object. The REST resource can be referenced within a client-server system. REST resources include, for example, HTML pages, images, files, videos, temporal services, objects, and collections of other resources. Accordingly, a REST API can be modeled as a collection of individually addressable resources. A root resource is one that links to all parts of the REST API.

Designed to work with the HTTP protocol, REST API resources map to URLs, which are REST API endpoints. REST API operations map to the HTTP protocol's POST, PUT, PATCH, and DELETE operations. The REST endpoints use HTTP verbs (POST, PUT, PATCH, and DELETE) that execute the basic CRUD actions (CREATE, READ, UPDATE, and DELETE) that operate on REST API resources. The REST API operation POST maps to CREATE. PUT likewise maps to CREATE, provided that a REST API's schema provides an id or uuid. PUT also maps to UPDATE. GET maps to READ. DELETE maps to DELETE. PATCH applies a partial modification to a resource and is somewhat analogous to the CRUD action UPDATE.

Another aspect of the inventive arrangements described herein is the generation of a sequence of operations, the operations belonging to a resource-specific group. An operation-based sequence tests an individual operation. A unique type of sequence, according to another aspect of the inventive arrangements, is a lifecycle sequence. A lifecycle sequence is one that corresponds to the life of a specific resource through sequence of operations, beginning with the resource's creation and ending with its deletion.

The ordering of operations within the sequence is based on dependencies between the operations and operation semantics of the sequence (e.g., CRUD). As used herein, “operation dependency” means a relationship between two operations whereby the output of one of the operations is a necessary input of the other operation. Yet another aspect of the inventive arrangements is a unique parameter matching technique for determining dependencies among operations, the determination made by matching certain parameters of the operations.

Still another aspect of the inventive arrangements is a unique subtyping of operations. “Operation subtyping,” as used herein, means refining or further defining an operation's type. In accordance with the inventive arrangements, operation subtypes are based on operation cardinality, operation functionality, and CRUD anomalies. Cardinality subtypes an operation according to whether an operation outputs one, some, or all resources that are inputs to another operation. A CRUD anomaly corresponds to an API schema's mischaracterization of an operation's type. Functionality identifies operations that do not create or operate on API resources (e.g., user login and logout). Operation subtyping, as provided by the inventive arrangements, enables more precise patterning of sequences of operations, providing a broader range of options for testing an API.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

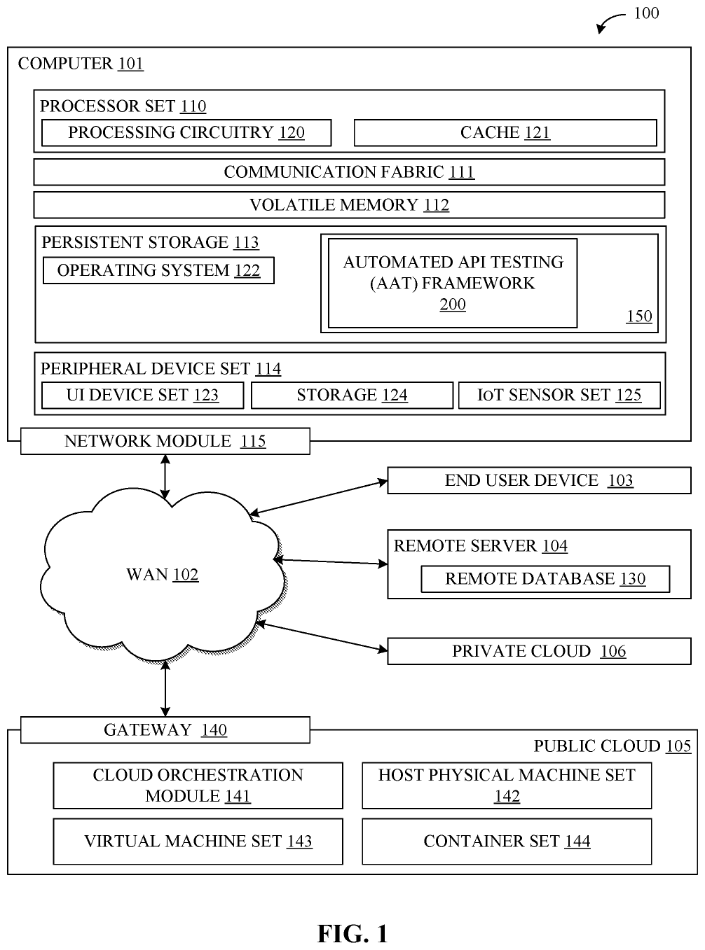

Referring to FIG. 1, computing environment 100 contains an example of an environment for the execution of at least some of the computer code in block 150 involved in performing the inventive methods, such as automated API testing (AAT) framework 200 implemented as executable program code or instructions. AAT framework 200 is capable of generating functional test cases of an API. The functional test cases include sequences of operations comprising operation-based sequences for testing individual operations of an API, as well as sequences comprising lifecycle-based sequences of operations for testing functional scenarios of the API's operations. A sequence is formed from a group of operations that act on a specific resource. The operations of a sequence are ordered based on dependencies between the operations, the dependencies based on a unique pattern matching technique that matches various operation parameters. Subtyping of the operations enables more precise sequencing of operations for greater specificity in API testing.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and AAT framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

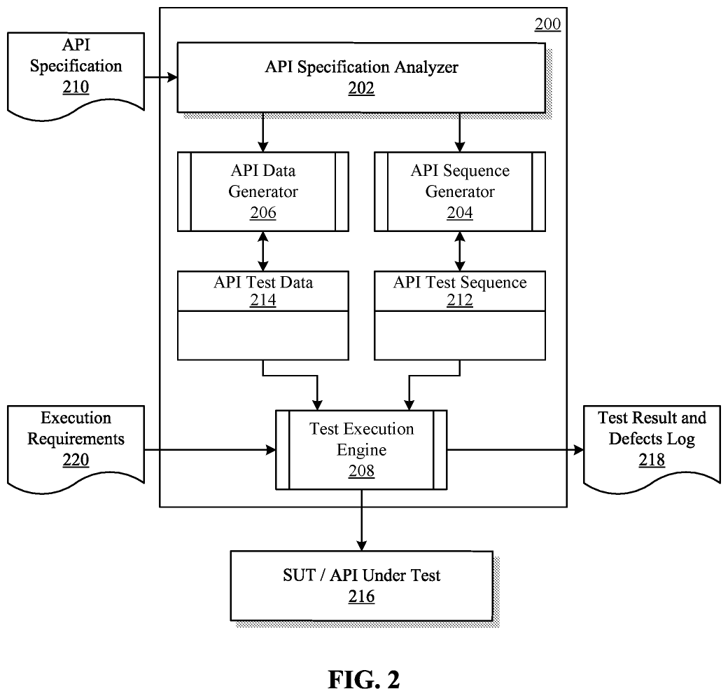

FIG. 2 illustrates an example architecture for the executable AAT framework 200 of FIG. 1. In the example of FIG. 2, AAT framework 200 illustratively includes API specification analyzer 202, API sequence generator 204, API data generator 206, and test execution engine 208.

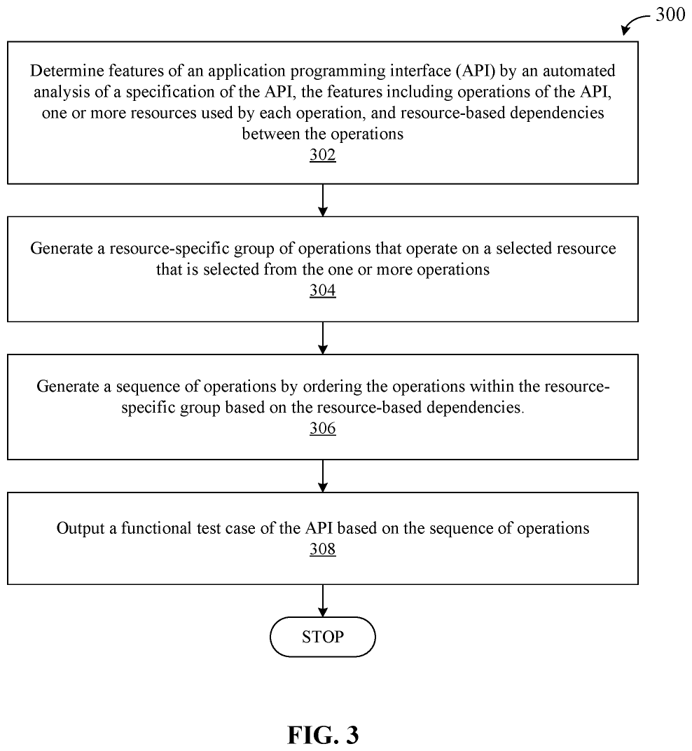

FIG. 3 illustrates an example method 300 of operation of AAT framework 200 of FIGS. 1 and 2. Referring to FIGS. 2 and 3 collectively, in block 302, API specification analyzer 202 is capable of determining features of an API based on the input of API specification 210. The features determined from API specification 210 by API specification analyzer 202 can include operations of the API, as well as one or more resources used by the operations. In certain embodiments, API specification analyzer 202 identifies an API resource from operation paths of API specification 210. In a REST API, a path is a callable object that comprises an HTTP verb and a path URL. API specification analyzer 202 in some embodiments implements an algorithm that generates a prefix tree by removing path parameters and associating operations with the nodes of the tree. Operations having a common prefix can be operations that operate with respect to a specific resource. As described in greater detail below, another of the features determined from API specification 210 by API specification analyzer 202 are resource-based dependencies between the operations.

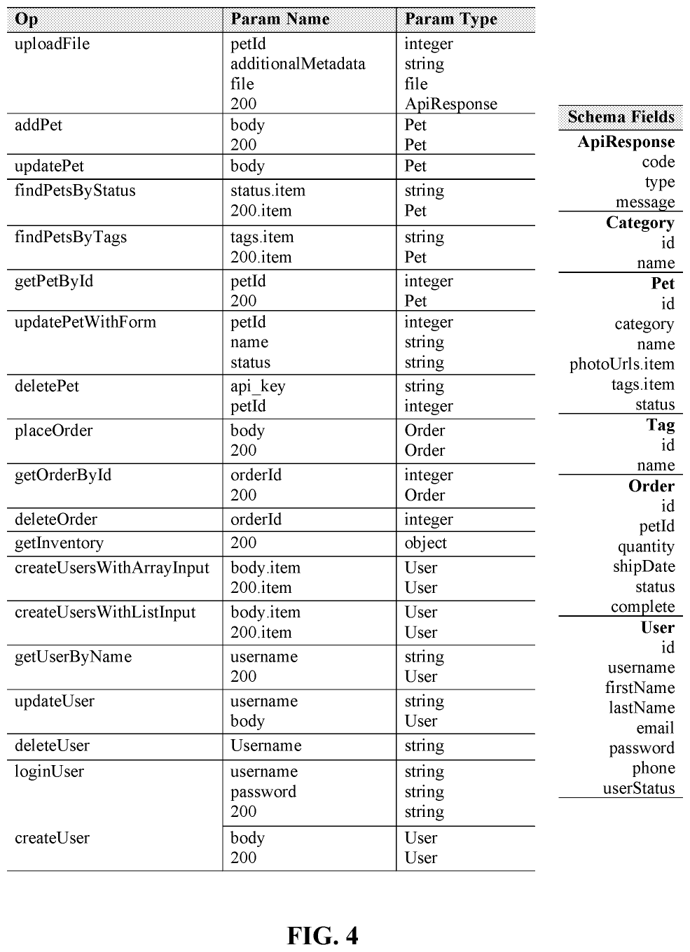

As an example of API specification 210, FIG. 4 illustrates a REST API specification comprising portions of the Swagger™ PetStore API specification. The portions illustrated include API operations (first column), parameter names and parameter types (second and third columns, respectively) for each of the operations, and schema fields (last column). A schema field indicates a type that defines the format for API data values.

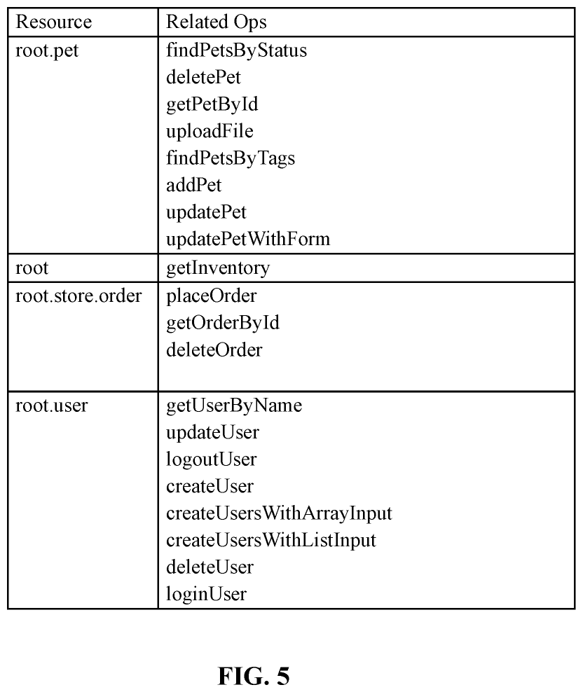

Referring still to FIGS. 2 and 3, in block 304, API sequence generator 204 generates a group of operations of the API. The grouping of operations is generated by determining, as described above, resources operated on by each of the API operations. For a specific resource, operations that operate on that resource are selected and grouped to generate a resource-specific group of operations. FIG. 5 illustrates four example resource-specific groups (second column) corresponding, respectively, to the resources root.pet, root, root.store.order, and root.user (first column). The resources are ones identified and extracted from the example API specification illustrated in FIG. 4.

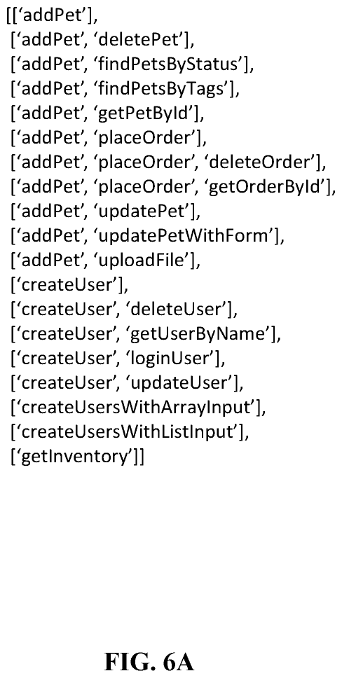

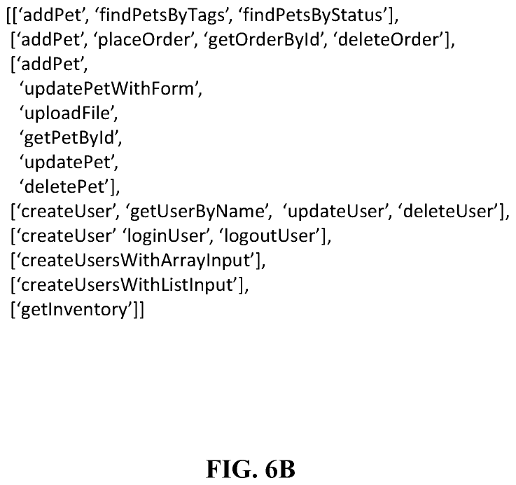

In block 306, API sequence generator 204 generates a sequence of operations of the resource-specific group generated in block 304. The sequence dictates an order with which the operations execute with respect to the specific resource. FIGS. 6A and 6B illustrate example sequences of operations corresponding to resources and operations specified by the example API specification illustrated in FIG. 4.

The sequences in FIG. 6A are operation based. An operation-based sequence is one that is used to test a specific operation with respect to a specific resource. Each horizontal line of FIG. 6A is an example operation-based sequence. Each set of brackets in FIG. 6A is an operation-based sequence. A sequence that includes more than one operation is one in which the operation under test requires an input that is generated by another operation, termed a prerequisite operation as described below. If two operations appear within brackets in FIG. 6A, then the first operation of the sequence is the prerequisite and the second operation is the operation tested.

The sequences in FIG. 6B are resource lifecycle based. Each set of brackets in FIG. 6B encloses a distinct lifecycle-based sequence. The order in which the operations within a set of brackets execute is shown by reading from left to right beginning with the leftmost operation. A lifecycle-based sequence includes the operations that span the entire lifecycle of a specific resource. For example, given a resource, the sequence can begin with the resource's creation with POST operation, followed by one or more GET, POST, and/or PATCH operations on the resource, and end with a DELETE operation that ends the resource's lifecycle.

The ordering of the operations within a sequence of resource-specific operations by API sequence generator 204 is determined by dependencies between the operations, as well as operational (e.g., CRUD) and functional semantics. The dependencies are among the features determined by API specification analyzer 202. API sequence generator 204 uses the dependencies to ensure that an operation that requires a resource as input is preceded by an operation that outputs the resource. The operation that outputs the resource is a producer, the other operation a consumer. The consumer receives an input designated by an id field of the resource that it consumes, where “consumes” means that the id appearing in the response to an operation is used—that is, “consumed”—as an input parameter of another operation. The producer is the operation that creates the resource by generating the id field. Producer-consumer dependencies are determined based on a unique procedure of parameter matching using a matching function implemented by API specification analyzer 202.

Apart from id fields, a consumer also can search at run-time for a resource through non-id fields. For example, consider the Swagger™ PetStore API operations addPet.200.status and findPetsByStatus.query.status.item. To determine what pet data is available, the consumer searches for data that has a status of value ‘sold’, where the status parameter's value of ‘sold’ returned in the output of addPet operation is consumed by another operation, findPetsByStatus listing the sold pets. Here status is not an id type field, but the data value of ‘sold’ is nonetheless consumed in one operation. Generally, a successful search by a consumer is ensured by an equality relationship between a producer's input or output and the consumer's input. The result is a data-availability relationship. Another data-availability relationship occurs if an operation outputs a resource that is produced by another operation. Like producer-consumer dependencies, data-availability relationships can determine a viable order for sequencing a resource-specific group of operations.

The id fields are fields of a schema. They refer to an operation parameter that uniquely identifies an associated resource. This is usually generated by the API or entered by the API user. An id referenced in the context of flattened parameters (e.g., ones whose values are indexed into one field as keywords) may be referred to as an id parameter, which is to be distinguished from an id. An id field of a schema is part of the parameter representation as defined from API specification analyzer 202's analyzing the specification and unrolling the schema, whereas an id referenced in the context of flattened parameters is part of the API semantics.

There is no assurance, however, that an API specification provides the information needed or that the information provided is adequate to match producers with consumers or determine data availability based on parameter matching. Therefore, API specification analyzer 202 implements a static analysis of the API specification. The analysis includes a search for path and query parameters that include sub-strings such as id, name, code, or uuid type. If the search does not return a parameter that meets the criteria, API specification analyzer 202 selects the parameter whose field is most frequently accessed from other operations.

API specification analyzer 202, given an operation (e.g., a potential consumer), searches for a match of all path and query parameters with the producer's fields (fields in a producer operation) and only id fields of any schema used in the input. To map a field in the producer operation to an appropriate field in the consumer operation, API specification analyzer 202 considers only those fields that are unique identifiers of the resource. For instance, the Swagger™ PetStore API operation addPet responds with a petId of the Pet data it created in a database. Thus, to call updatePet, the user needs to pass some identifier of Pet data to update. Once called operation updatePet uses (consumes) the petId produced by addPet and updates it accordingly.

Although API specification analyzer 202 searches id fields of a producer and a consumer, other fields are searched with respect to an id field of a resource. The id field of a resource can be represented in a producer (operation that produces the resource) and a consumer (operation that consumes the resource) in different ways. In a producer, the resource can be just ‘id’ but, in the consumer, the resource can be identified differently (e.g., ‘petid’). Therefore, as described in the following paragraph, API specification analyzer 202 utilizes a matching function to identify and match the producer and consumer of the resource. The matching function is capable of identifying both a producer-consumer relationship and a data-availability relationship. Note, a data-availability relationship is not limited to a match of id fields.

For a given operation that is a potential consumer, API specification analyzer 202 searches for a match of all the path and query parameters of the potential consumer with a producer operation's fields and only id fields of the schema. Given the features of two fields, API specification analyzer 202 implements a matching function that returns a rank based on feature comparisons. The rank is a weighted function of (1) type match; (2) field name match (exact or substring); (3) schema or resource name match between two operations; and (4) match between nouns in the consumer's field name with a schema/resource name. Each of (1) through (4) can take on a value of one if there is a match, or zero if there is no match. The values of (1) through (4) can be weighted. For example, values of (1) through (4) can be weighted, respectively, by weight coefficients 3, 3, 1, and 2. The rank is a sum of the weighted values. The producer field, as described above, is an id field of a producer schema. The consumer field is the field of a consumer operation that most closely matches the fields of each producer, the closeness determined according to the ranks generated by the weighted function. One consumer field may match multiple producers of the same resource.

In addition to determining dependencies between operations, API specification analyzer 202 also can subtype the operations. Subtyping can be based on operation cardinality, operation functionality, and/or a CRUD anomaly. Cardinality is determined according to whether an operation works on a single resource or multiple resources and can be inferred by the presence of a schema list or array for either the input or output of the operation. Functional operations are operations whose verb does not match a synonym of a GET, PUT, or PATCH operation (e.g., loginUser or logoutUser) and has only limited usefulness for API testing.

API specification analyzer 202, in certain embodiments, adds a suffix to each operation type to indicate cardinality. A “one” suffix indicates the operation works only with one resource. An “all” suffix indicates the operation works with multiple resources.

In certain embodiments, API specification analyzer 202 implements an input-output pattern-based matching algorithm or keyword-based matching algorithm to identify CRUD anomalies. Such an anomaly arises if the API uses an operation against type. For example, it is not uncommon for a developer to use a POST operation not only to create a resource but also to update the resource, a PUT operation, or perform a functional operation. The operation so used is subtyped by API specification analyzer 202 as a POST-PUT operation based on the anomaly.

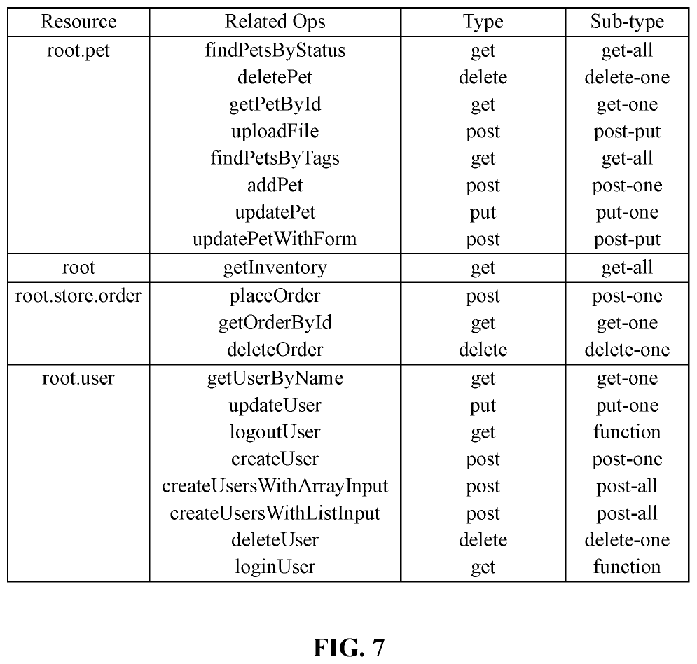

FIG. 7 illustrates a typing and subtyping of the operations in the example API specification illustrated in FIG. 4. The subtyping is used by API sequence generator 204 to identify producers. For example, a producer is an operation whose type of that of POST and that creates a resource id that is consumed by another operation. If the subtype of a POST, however, is a POST-PUT subtype, then there is a CRUD anomaly. The subtype indicates that the POST actually updates a resource or is a functional operation and is thus not in fact a producer.

In certain embodiments, API sequence generator 204 generates a per-resource operation graph Gr=(Vr, Er) for a given sub-type relationship, where r indicates a specific resource associated with a resource-specific group of operations, and where Vr and Er indicate, respectively, the vertices (or nodes) and edges of the graph, respectively. The per-resource operation graph Gr can include a quantifier mapping Q: S [symbol] {one, all}. The quantifier indicates that an operation (e.g., POST, DELETE) of the given subtype does not repeat (indicated by “one”) or that that the operation (e.g., GET/PUT/PATCH) repeats multiple times in the sequence.

Additionally, API sequence generator 204 determines whether there is no Vr node that is a producer and is a parent of an Er connected node Vr′ that is a consumer, indicating that there is no input resource as required by Vr′. API sequence generator 204 responds by supplying a prerequisite node to the graph Gr to ensure that an operation, as producer, precedes an operation that is a consumer.

API sequence generator 204, in generating lifecycle sequences (as distinct from operation-based) recursively adds producers along with their edges. If there are multiple producers for the same consumer, then multiple graphs can be generated, each corresponding to a different producer. For any operation subtyped POST-ONE that is added as a prerequisite, API sequence generator 204 also adds other POST-ONE operations recursively based on their predetermined dependencies with respect to the same resource.

With respect to the ordering of operations in a lifecycle sequence, each per-resource graph has three types of ordering edges Er. For the multiple operations, API sequence generator 204 implements a novel ordering procedure that uses the natural order of the operation's verbs. API sequence generator 204 uses a transformer language model with all permutations of the verbs and chooses the ordering which has the highest probability of correctly ordering execution of the operations based on the relative frequency with which each particular sequence occurs within a random sample. A language model, trained on a large corpus of sentences, yields the conditional probability of the next word given a sequence of previous words. The probability is based on the distribution of the next word given the previous words. The distribution of the next word is based on the frequency of the next word given the sequence of previous words, and so on. The probability of a sequence is the product of all such conditional probabilities. For example, for three words w₁, w₂, and w₃, the probability of the sequence w₁w₂w₃ is P(w₁w₂w₃)=P(w₁)·P(w₂|w₁)·P(w₃|w₁w₂).

To break a partial order between GET, PUT or PATCH operations for resources, API sequence generator adds ordering edges between operations according to their type, GET, PUT, or PATCH. For any operation edges Er between POST-ONE and POST-PUT operations added as a prerequisite, API sequence generator 204 adds outgoing edges from the POST-PUT operation to the same target operations of POST-ONE to maintain their subsequent ordering. API sequence generator 204 generates the final sequence based on the topological order of the Vr of per-resource operation graph Gr=(Vr. Er).

Referring again to FIGS. 2 and 3, in block 308, test execution engine 208 outputs a functional test case of the API based on the sequence of operations. The operations of the sequence can be ordered according to the topological order of the Vr of per-resource operation graph Gr=(Vr. Er).

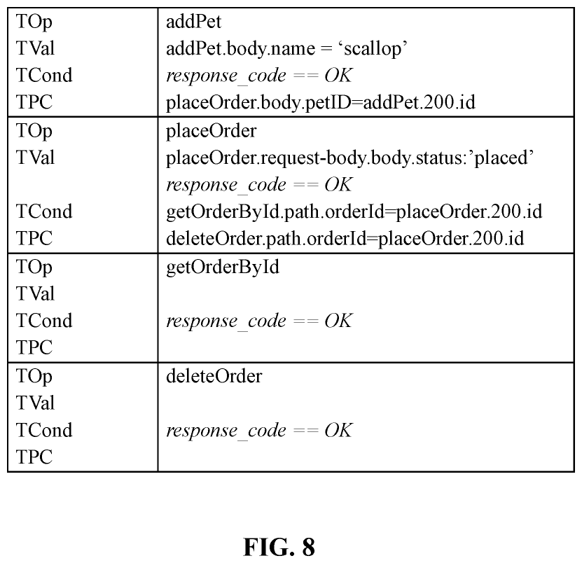

FIG. 8 illustrates a functional API test case for a resource-specific group of operations drawn from the example API specification illustrated in FIG. 4. The first line of each of the four blocks shown correspond to an operation. Illustratively, reading down from top to bottom, the operations are addPet (first line, first block), placeOrder (first line, second block), getOrderById (first line, third block), and deleteOrder (first line, fourth block). The operations execute in descending order. The second line maps values to a subset of input parameters. The third line is a response check. The response check takes on certain values of REST API response codes (e.g., 200—OK) indicating the result of executing an operation. The fourth line of each block is an optional indicator that maps output parameters of an operation (producer) to the input parameters of another operation (consumer) later in the sequence.

Notationally, each operation and corresponding execution result can be represented by a vector (TOp, TVal, TCond, TPC), where each operation corresponds to TOpᵢ∈O, O is the set of operations, and i is an index between one and four. TVal/maps a subset of input parameters TOpᵢ. IP to specific values. TCondᵢ is a Boolean expression indicating the output of TOpᵢ.OP. TPCᵢ⊆{TOpᵢ.OP×TOpⱼ.IP|i<j} (written as TOpⱼ.IP=TOpᵢ.OP) is the optional parameter that denotes the mapping from some of the output parameters of an operation (producer) to the input parameters of another operation (consumer) later in the sequence, that is i<j.

Test execution engine 208 executes a functional API test case by sequentially executing each operation TOpᵢ, instantiating the values generated using TValᵢ, executing each operation and receiving a response, and calculating the condition TCondᵢ based on the response. If the check is satisfied, the test engine further updates the state by extracting the producer field value TOpᵢ. OP from the response, which can be used for a consumer's field (TOpⱼ.IP) instantiation.

Test execution engine 208 outputs the functional API test case to system-under-test (SUT) 216 for testing the API. Based on the testing, test execution engine 208 generates test results and defects log 218.

API Specification 210 enables developers to specify the validity constraints, which can be input as part of execution constrains 220 to test execution engine 208 for testing the API. For example, a developer can specify categorical and/or enumerated type constraints, regularized expressions, string lengths, numeric ranges, and the like for each input parameter. Test execution engine 208 can model the constraints and can generate multiple values for each parameter satisfying the constraints.

API sequence generator 204 can repeat the process described to generate a suite of functional API test cases. Different functional API test cases can be generated for three types of parameter scenarios for each operation: a mandatory parameter scenario, an optional parameter scenario, and an all-parameter scenario. In the mandatory parameter scenario, one parameter set includes all mandatory parameters. In each optional parameter scenario, AAT framework 200 tests one specific optional parameter, and the corresponding parameter set includes all mandatory parameters, the target optional parameter, and other parameters that are mandatory for all schema in the nested hierarchy of the target optional parameter. In the all-parameter scenario, API sequence generator 204 utilizes one parameter set that includes all parameters.

API data generator 206 can provide data to test execution engine 208 for use in executing a functional API test. In certain embodiments, API data generator 206 retrieves test data from a curated repository of public comma separated values (CVS) files. In contrast to conventional techniques of API testing that generate random values or simply rely on user-provided values, API data generator 206 uses a repository-based data retrieval for API testing. API data generator 206, in certain embodiments, implements a two-phase process of data retrieval. In the first phase, API data generator 206 sets up the repository by creating an index. In the second phase, API data generator 206 uses the index to effectively retrieve data satisfying the objective of ensuring highly associative, constraint-based or syntactically diversified data retrieval. The repository, R, is created with a set of CSV files, F, where each file has a name (F.name) and a dataset name (F.ds). R contains a table with columns (F.cols) and values (F.vals). In an offline setup phase, for each column, API data generator 206 creates a representation containing the features that comprise column types, nouns present in the column name, file names, and dataset names. The setup also identifies the predominant syntactic patterns (if any) for each column.

API data generator 206 implements an algorithm that, for each operation, generates a table with all an operation's input parameters. For each input parameter that is not part of a producer-consumer or data-availability relationship or an enumerated type, or has a unique constraint, API data generator 206 determines a set of matching table columns using a representation comprising the feature's column name, schema name, and the resource name. In the event that API data generator 206 does not find any matching column in the repository (either by name matching or by constraint satisfaction), then API data generator 206 resorts to constraint solver-based generation for each parameter, if constraints are present. Otherwise, API data generator 206 randomly generates API test data.

The terminology used herein is for the purpose of describing particular embodiments only and is not intended to be limiting. Notwithstanding, several definitions that apply throughout this document now will be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C.” “at least one of A, B. or C.” “one or more of A, B, and C.” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including.” “comprises,” and/or “comprising.” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising
determining, by a specification analyzer, features of an application programming interface (API), wherein the features include operations of the API, one or more resources used by each operation, and resource-based dependencies between the operations;
generating, by a sequence generator, a resource-specific group of operations, wherein operations within the resource-specific group operate on a selected resource selected from the one or more resources;
generating, by the sequence generator, a sequence of operations by ordering the operations within the resource-specific group based on resource-based dependencies between the operations within the resource-specific group; and
outputting, by a test execution engine, a functional test case of the API based on the sequence of operations.

2. The method of claim 1, wherein the determining resource-based dependencies includes performing a parameter matching of parameters of the operations.

3. The method of claim 1, wherein the resource-based dependencies correspond to producer-consumer relations between operations.

4. The method of claim 1, wherein the method further comprises:
determining subtypes of the operations of the API; and
wherein the generating the resource-specific group of operations includes generating the resource specific group based on subtypes of the operations within the resource-specific group.

5. The method of claim 1, wherein the generating the sequence of operations includes:
determining, using a transformer language model, probabilities of multiple permutations of orderings of operations within the resource-specific group, wherein the operations within the resource-specific group are permutated based on recognized verbs of the operations; and
generating the sequence based on a permutation having a greatest probability.

6. The method of claim 1, wherein the method further comprises:
executing the functional test case on a system under test; and
performing a response check with respect to each of the selected operations.

7. The method of claim 1, further comprising:
generating additional functional test cases of selected operations arranged based on the sequence of operations using different combinations of parameter values for the selected operations.

8. The method of claim 1, wherein the sequence of operations is a lifecycle-based sequence corresponding to the lifecycle of the selected resource.

9. The method of claim 1, wherein the sequence of operations is an operation-based sequence.

10. A system, comprising:
one or more processors configured to execute operations including:
determining features of an application programming interface (API), wherein the features include operations of the API, one or more resources used by each operation, and resource-based dependencies between the operations;
generating a resource-specific group of operations, wherein operations within the resource-specific group operate on a selected resource selected from the one or more resources;
generating a sequence of operations by ordering the operations within the resource-specific group based on resource-based dependencies between the operations within the resource-specific group; and
outputting a functional test case of the API based on the sequence of operations.

11. The system of claim 10, wherein the determining resource-based dependencies includes performing a parameter matching of parameters of the operations.

12. The system of claim 10, wherein the resource-based dependencies correspond to producer-consumer relations between operations.

13. The system of claim 10, wherein the one or more processors are configured to initiate operations further including:
determining subtypes of the operations of the API; and
wherein the generating the resource-specific group of operations includes generating the resource specific group based on subtypes the operations within the resource-specific group.

14. The system of claim 10, wherein the generating the sequence of operations includes:
determining, using a transformer language model, probabilities of multiple permutations of orderings of operations within the resource-specific group, wherein the operations within the resource-specific group are permutated based on recognized verbs of the operations; and
generating the sequence based on a permutation having a greatest probability.

15. The system of claim 10, wherein the one or more processors are configured to initiate operations further including:
executing the functional test case on a system under test; and
performing a response check with respect to each of the selected operations.

16. The system of claim 10, wherein the one or more processors are configured to initiate operations further including:
generating additional functional test cases of selected operations arranged based on the sequence of operations using different combinations of parameter values for the selected operations.

17. The system of claim 10, wherein the sequence of operations is a lifecycle-based sequence corresponding to the lifecycle of the selected resource.

18. The system of claim 10, wherein the sequence of operations is an operation-based sequence.

19. A computer program product comprising:
one or more computer readable storage media having program instructions embodied therewith, wherein the program instructions are executable by one or more processors to cause the one or more processors to execute operations comprising:
determining features of an application programming interface (API), wherein the features include operations of the API, one or more resources used by each operation, and resource-based dependencies between the operations;
generating a resource-specific group of operations, wherein operations within the resource-specific group operate on a selected resource selected from the one or more resources;
generating a sequence of operations by ordering the operations within the resource-specific group based on resource-based dependencies between the operations within the resource-specific group; and
outputting a functional test case of the API based on the sequence of operations.

20. The computer program product of claim 19, wherein the determining resource-based dependencies includes performing a parameter matching of parameters of the operations.
